(19) United States
(12) Patent Application Publication
(10) Pub. No.: US 2009/0025871 A1
(43) Pub. Date: Jan. 29, 2009

(54) INFRARED PREHEATING FOR CARTON MATERIAL SEALING

(75) Inventors: Ann Marie Ash, Brooklyn Park, MN (US); Thomas S. Breidenbach, Maple Grove, MN (US)

Correspondence Address: Levenfeld Pearlstein LLC (Tetra Pak), 2 North LaSalle Street, Suite 1300, Chicago, IL, 60602, US

(73) Assignee: TETRA LAVAL HOLDINGS & FINANCE S.A., Pully (CH)

(21) Appl. No.: 11/782,240

(22) Filed: Jul. 24, 2007

(51) Int. Cl. B32B 37/06

(52) U.S. Cl. 156/275.1; 156/380.9

(57) ABSTRACT

An infrared preheater preheats the first and second surfaces of an edge-proximate portion of a package that is formed from a polymeric material. The first and second surfaces on opposing sides of a sheet of material in which the surfaces are sealed to one another or to another element at the edge-proximate portion. The preheater includes an infrared energy emitting element disposed to emit infrared energy directly toward the first surface of the edge-proximate portion to preheat the first surface of the edge-proximate portion. An energy reflective element is disposed in opposing relation to the energy emitting element. The energy reflective element is positioned such that at least a portion of the energy that is emitted from the emitting element that does not strike the first surface of the package strikes the energy reflective element and is reflected back to the second surface to preheat the second surface of the edge-proximate portion. A method for preheating the first and second surfaces of the edge-proximate area is also disclosed.

### BACKGROUND OF THE INVENTION

This invention is directed to an apparatus and method for preheating portions of a carton material prior to sealing a element to the carton material or sealing the carton material to itself. More specifically, the invention pertains to an apparatus and method for infrared preheating the plastic (polymeric) layers on paperboard material prior to sealing or molding an element such as a closure onto the material or prior to sealing the material to itself.

Many different types of packaging material are known. One commonly used material is a paperboard based material that has one or more gas and/or liquid impermeable layers that form a laminate with the paperboard substrate. For example, a paperboard substrate can have one or more polyethylene layers and a foil layer on an inner (food contact) surface and one or more polyethylene layers on an outer surface. Other suitable materials can also be used.

These materials can be used to form packages of different shapes, such as gable top cartons, brick-type packages, wedge-shape packages, octagonal-shape packages and the like. In some of these packages the package opening is created by separating sealed panels (e.g., fins) from one another to dispense product. In other packages, separate, pre-molded closures elements (e.g., spouts with caps) are affixed to the packaging material through which product is dispensed from the package. In still other packages, closures are molded directly onto the packaging material.

To effect a seal of the material to itself (as in the case of fins) or of the material to a separate element (as in the case of pre-molded or direct molded closures), energy in the form of heat, ultrasonic energy or the like is transmitted into the packaging material to soften the polymer coatings. The portions to be sealed are then brought together, and under an applied pressure the seal is formed by fusion and subsequent cooling of the materials. Heating is provided by application of ultrasonic energy (which requires contact), induction heating (which requires a conductive element such as a metal foil in the package), or by application of hot air (which can be slow, can cause turbulence and may carry contaminants).

In certain instances, it is advantageous to heat both sides of the material (for example, both an inside surface and an outside surface) prior to sealing the material and/or element. This is particularly so when the material is sealed at both surfaces.

Accordingly, there is a need for an apparatus and method for preheating a carton material prior to sealing the material. Desirably such an apparatus and method uses a single source to heat both surfaces. More desirably, such an apparatus and method uses active and passive elements to heat the surfaces.

### BRIEF SUMMARY OF THE INVENTION

An infrared preheater preheats first and second surfaces of an edge-proximate portion of a package formed from a polymeric material in which the first and second surfaces are on opposing sides of a sheet of material. The preheated surfaces are sealed to one another or to another element at the edge-proximate portion. The first and second surfaces can be on opposite sides of the package material or on the same side of the package material.

The preheater includes an infrared energy emitting element disposed to emit infrared energy directly toward the first surface of the edge-proximate portion to preheat the first surface of the edge-proximate portion. An energy reflective element is disposed in opposing relation to the energy emitting element. The reflective element is positioned such that at least a portion of the energy that is emitted from the emitting element that does not strike the first surface of the package strikes the reflective element and is reflected back to the second surface to preheat the second surface of the edge-proximate portion.

In a present embodiment, the emitting element is an infrared heating bulb that resides in a reflector. The energy reflective element (opposite of the emitter) is a non-planar, shaped reflective element. Preferably, the reflective element is shaped to reflect energy outwardly relative to a center of the reflective element. That is, the reflective element reflects the energy toward the second surface, away from the emitting element. The reflective element can reflect energy outwardly in a generally annular shape relative to a center of the reflective element.

In a present embodiment, the energy emitting element is disposed at an exterior of the package and the energy reflective element is disposed in an interior of the package.

A method for preheating the first and second surfaces on opposing sides of a sheet of material to seal the surfaces to one another or to another element at the edge-proximate portion includes the steps of positioning an infrared energy emitting element to emit energy in the direction of the first surface at the edge-proximate portion of the package, positioning an energy reflective element in a portion of a path of the energy emitting element, exposing at least a portion of the first surface at the edge-proximate portion to energy from the energy emitting element to preheat the first surface of the edge-proximate portion and reflecting a portion of the infrared energy to expose at least a portion of the second surface at the edge proximate portion to preheat the second surface of the edge-proximate portion.

These and other features and advantages of the present invention will be apparent from the following detailed description, in conjunction with the appended claims.

### BRIEF DESCRIPTION OF THE SEVERAL VIEWS OF THE DRAWINGS

The benefits and advantages of the present invention will become more readily apparent to those of ordinary skill in the relevant art after reviewing the following detailed description and accompanying drawings, wherein:

FIGS. 1A and 1B illustrate an exemplary blank fed form, fill and seal machine that includes an infrared preheater for carton material sealing in accordance with the principles of the present invention;

FIG. 2 illustrates, generally, a roll-fed form, fill and seal machine on which the present infrared preheater for carton material sealing can be used;

FIG. 3 is a partial perspective view of one embodiment of an infrared preheating system for carton material sealing in accordance with the principles of the present invention;

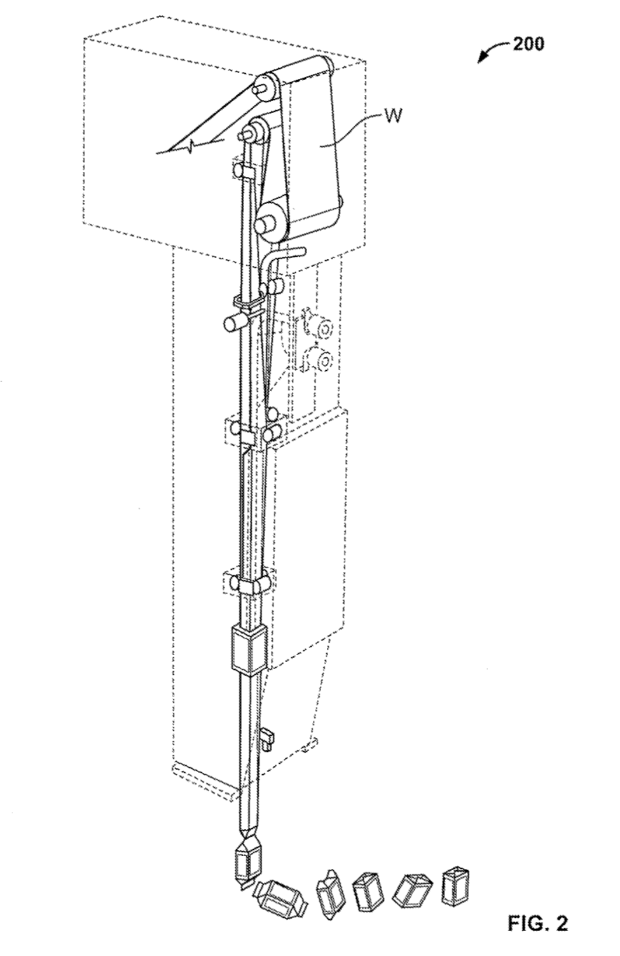

FIG. 4 is a bottom perspective view of a portion of the system illustrated in FIG. 3;

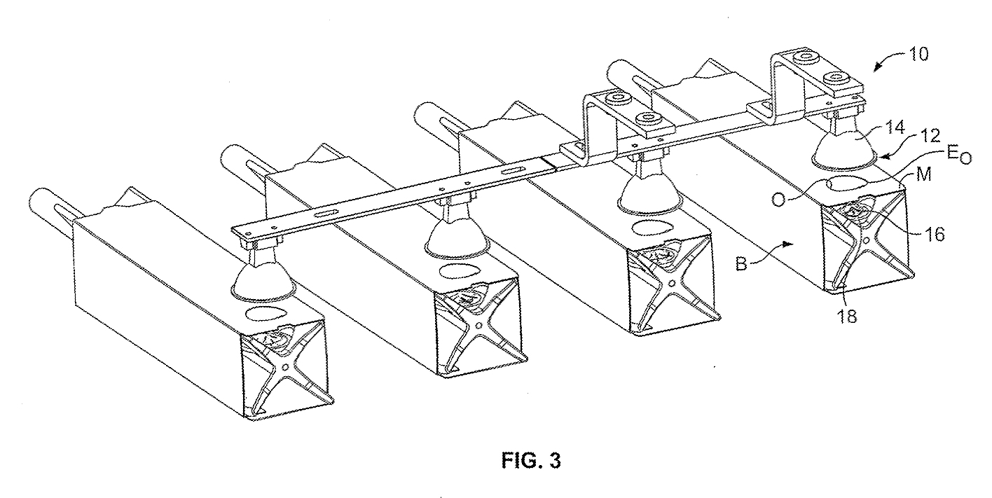

FIG. 5 is an enlarged top perspective view similar to FIG. 3;

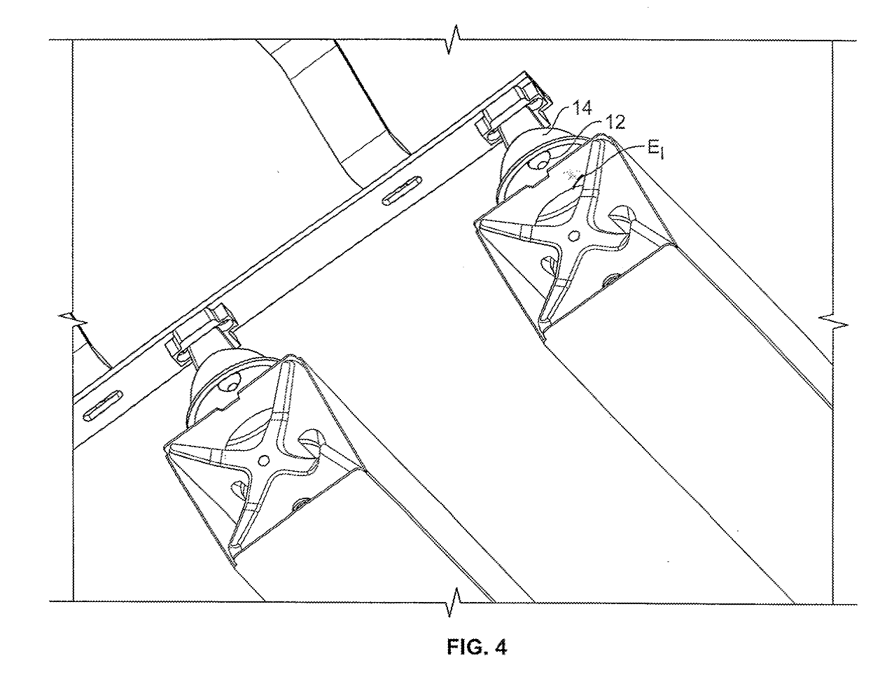

FIG. 6 is an enlarged partial perspective view of the infrared preheating system for carton material sealing in a web-fed form, fill and seal machine; and

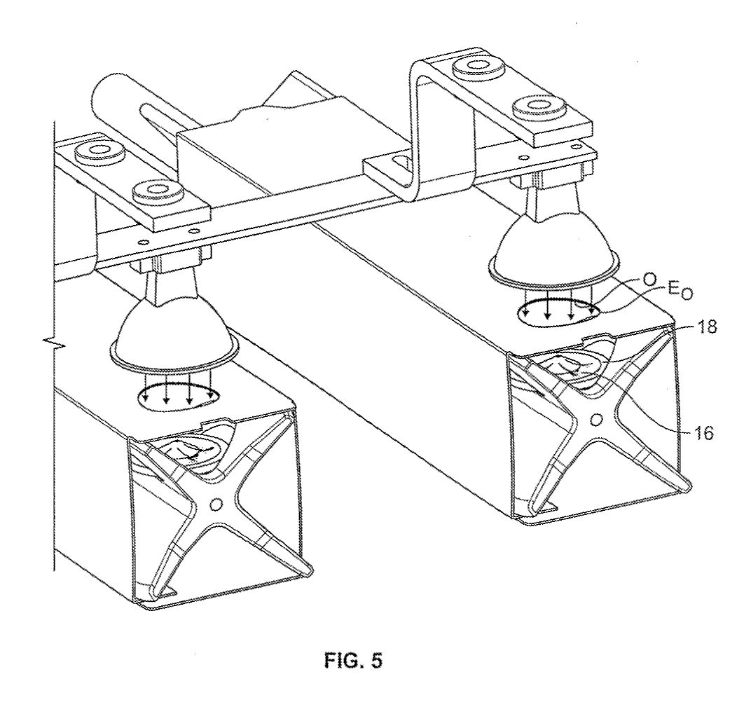

FIG. 7 illustrates, schematically, an exemplary closure that is molded to a package.

### DETAILED DESCRIPTION OF THE INVENTION

While the present invention is susceptible of embodiment in various forms, there is shown in the drawings and will hereinafter be described a presently preferred embodiment with the understanding that the present disclosure is to be considered an exemplification of the invention and is not intended to limit the invention to the specific embodiments illustrated.

It should be further understood that the title of this section of this specification, namely, “Detailed Description Of The Invention”, relates to a requirement of the United States Patent Office, and does not imply, nor should be inferred to limit the subject matter disclosed herein.

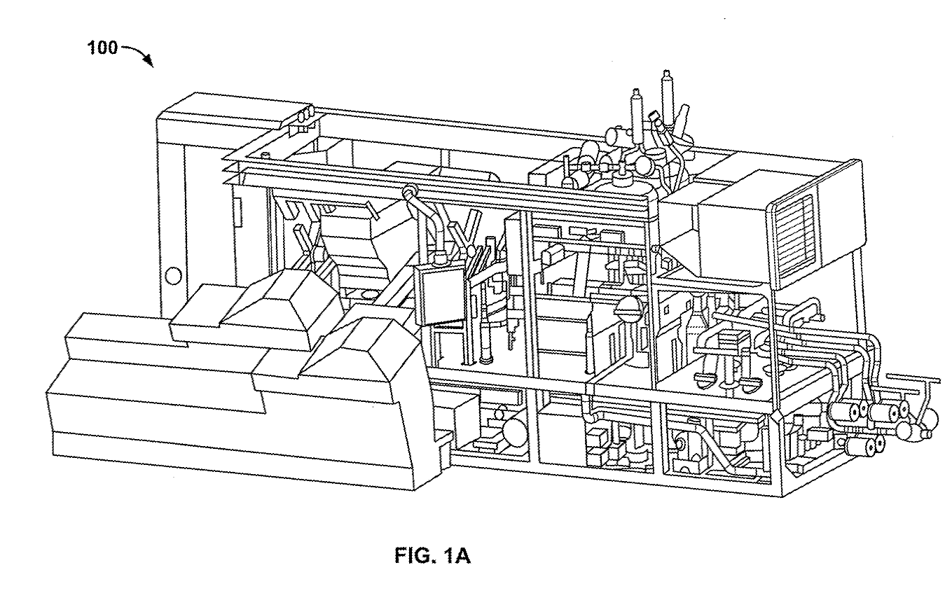

Referring now to the figures and in particular to FIGS. 1A and 1B, there is shown an exemplary blank fed form, fill and seal packaging machine 100 that stores carton blanks B, erects the blanks (to seal the seal the bottoms), fills and seals the cartons. Such an exemplary form, fill and seal packaging machine 100 is disclosed in Katsumata, U.S. Pat. No. 6,012,267, which patent is assigned to the assignee of the present invention and is incorporated herein by reference. In a conventional configuration, a pre-molded closure package (e.g., spout and cap) is affixed to the package at an interior of the package (an inside surface of the package), by inserting the closure through a preformed opening in the package material and ultrasonically welding a flange of the spout to the package material.

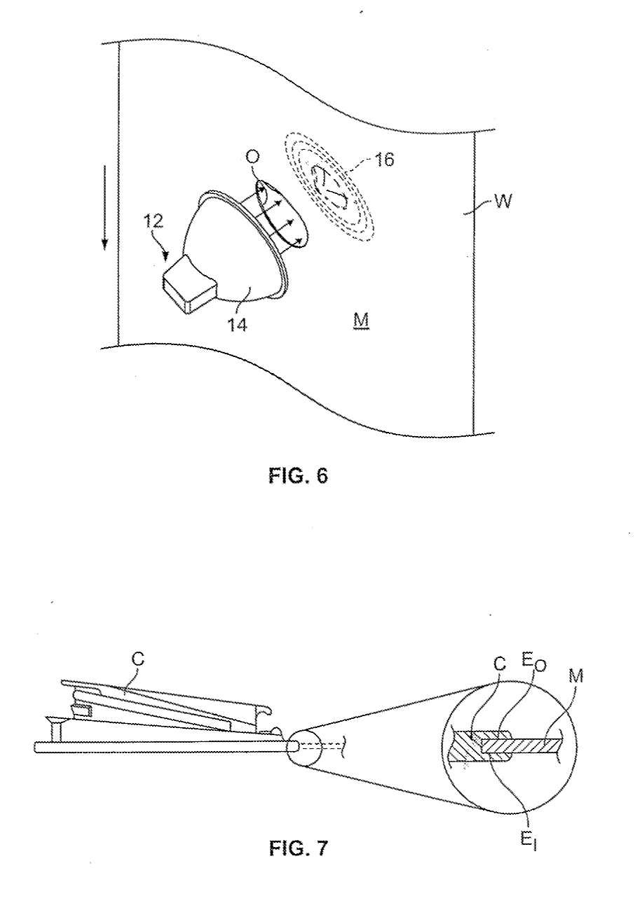

In another configuration, a molding apparatus 110 provides for the closure C to be molded directly onto the package material M at a preformed opening O in the material. Referring briefly to FIG. 7, in this configuration, the closure C is molded onto the package B such that the closure encapsulates the edges of the opening O, at both the interior and exterior surfaces E_{I} and E_{O}, respectively, of the package material M. A system for direct injection molding closures onto blank fed materials is discloses in Lees at al., U.S. Pat. No. 6,467,238, which patent is assigned to the assignee of the present invention and is incorporated herein by reference. It will be understood that the terms interior and exterior are in reference to the formed package and as such the interior surface is that surface in contact with the food product and the exterior surface is that surface that is not in contact with the food product.

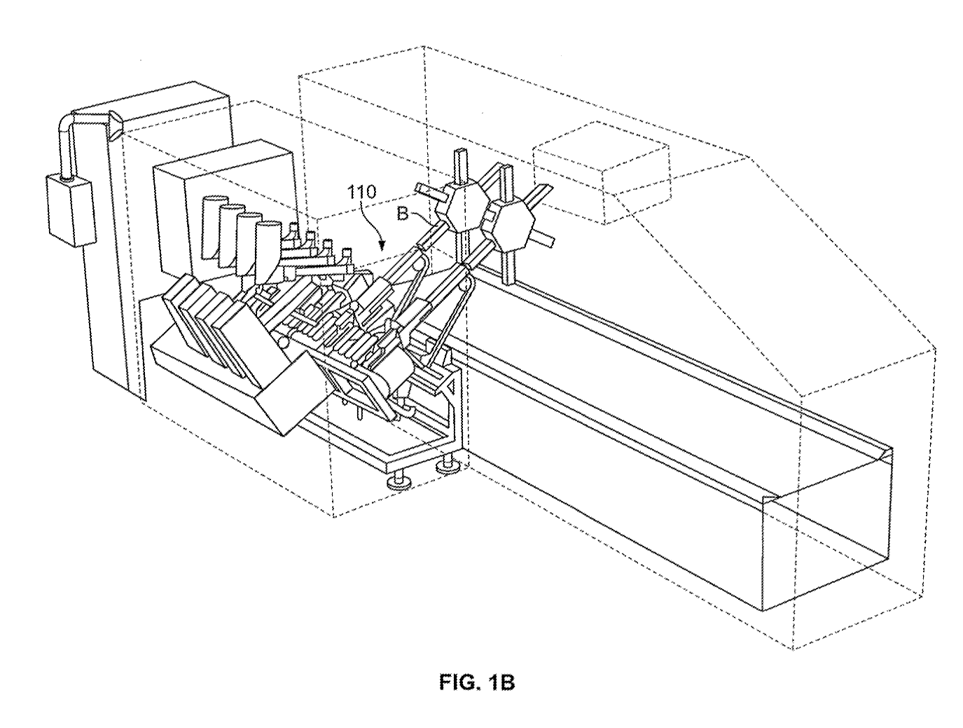

Closures can also be formed (e.g., molded) onto a continuous web W of packaging material in a machine such as that shown in FIG. 2. An example of such a machine is disclosed in Andersson, U.S. Pat. No. 5,667,745, which patent is assigned to the assignee of the present invention and is incorporated herein by reference.

It has been found that to provide an enhanced seal between the closure C and the packaging material M it is most advantageous to preheat the material prior to application of the closure. And, it has been found to be most advantageous to heat the material at those areas, the edge-proximate areas or portions E_{I}, E_{O}, at which the closure C will come into contact with the packaging material M.

A present preheating system 10 uses an infrared energy emitting element or source 12, such as an infrared light source, directed on the surface of the material M at the location at which the closure is applied to the material. The infrared energy serves to heat and soften the material to promote fusion of the softened polymer of the packaging material to the material to which it is sealed (e.g., a closure or another portion of the package). In a present embodiment, the energy source 12 is positioned within a reflector 14 which can, for example, be parabolic in shape. Such a parabolic reflector will generally reflect the energy in primarily parallel rays. Reflectors of other shapes can be specifically shaped to cast a portion of the emitter rays on an intensified annular region or in any desired manner.

In order to further enhance the seal, a passive energy reflective element 16 is disposed spaced from and facing the infrared source 12. The reflective element 16 is positioned at the inside of the package B (as opposed to the infrared source 12 which is positioned at the outside of the package) opposite and facing the source 12. The package material M, which has an opening O to receive the closure, provides an open area through which the infrared source energy that does not strike the exterior edge-proximate portion E_{O} is then reflected back onto the inside surface of the packaging material (at the interior edge-proximate portion E_{I}). In this manner, a single infrared source 12 provides the energy to heat the material M around the opening O at both the exterior surface E_{O} (directly) and the interior surface E_{I} (indirectly, by reflection). This configuration eliminates the need for two emitters (at one sealing location) and/or allowing infrared energy to be cast from a direction where an emitter may not survive and/or be readily powered.

In a present embodiment, the reflective element 16 is configured to both reflect the infrared energy and to focus and intensify the reflection onto the edges E_{I} of the packaging material M at the opening O. Accordingly, rather than a flat reflective mirror, the reflective surface is non-planar and is in fact shaped, as indicated at 18 to reflect the energy in a pattern out toward the edges E_{I} of the material M to be sealed (e.g., the opening O).

It will also be appreciated that the first and second surfaces can be on opposite sides of the package material (an inside and an outside) or on the same side of the package material (e.g., the insides of two panels sealed to one another). In any such arrangement, a combination of direct infrared energy and reflected infrared energy can be used to heat any such surfaces.

In the present disclosure, the words “a” or “an” are to be taken to include both the singular and the plural. Conversely, any reference to plural items shall, where appropriate, include the singular.

All patents referred to herein, are hereby incorporated herein by reference, whether or not specifically done so within the text of this disclosure.

From the foregoing it will be observed that numerous modifications and variations can be effectuated without departing from the true spirit and scope of the novel concepts of the present invention. It is to be understood that no limitation with respect to the specific embodiments illustrated is intended or should be inferred. The disclosure is intended to cover by the appended claims all such modifications as fall within the scope of the claims.

What is claimed is:

1. An infrared preheater for preheating first and second surfaces of an edge-proximate portion of a package formed from a polymeric material, the first and second surfaces on opposing sides of a sheet of material in which the surfaces are sealed to one another or to another element at the edge-proximate portion, comprising:
an infrared energy emitting element disposed to emit infrared energy directly toward the first surface of the edge-proximate portion to preheat the first surface of the edge-proximate portion; and
an energy reflective element disposed in opposing relation to the energy emitting element, the energy reflective element positioned such that at least a portion of the energy that is emitted from the energy emitting element that does not strike the first surface of the package strikes the energy reflective element and is reflected back to the second surface to preheat the second surface of the edge-proximate portion.

2. The infrared preheater in accordance with claim 1 wherein the infrared energy emitting element is an infrared heating bulb and wherein the infrared heating bulb resides in a reflector.

3. The infrared preheater in accordance with claim 1 wherein the energy reflective element is a non-planar, shaped reflective element.

4. The infrared preheater in accordance with claim 3 wherein the energy reflective element is shaped to reflect energy outwardly relative to a center of the reflective element.

5. The infrared preheater in accordance with claim 4 wherein the energy reflective element is shaped to reflect energy outwardly in a generally annular shape relative to a center of the reflective element.

6. The infrared preheater in accordance with claim 1 wherein the infrared energy emitting element is disposed at an exterior of the package and the energy reflective element is disposed in an interior of the package.

7. A method for preheating first and second surfaces on opposing sides of a sheet of material in which the surfaces are sealed to one another or to another element at the edge-proximate portion, comprising:
positioning an infrared energy emitting element to emit energy in the direction of the first surface at the edge-proximate portion of the package;
positioning an energy reflective element in a portion of a path of the energy emitting element;
exposing at least a portion of the first surface at the edge-proximate portion to infrared energy from the infrared energy emitting element to preheat the first surface of the edge-proximate portion; and
reflecting a portion of the infrared energy to expose at least a portion of the second surface at the edge proximate portion to preheat the second surface of the edge-proximate portion.

8. The method in accordance with claim 7 wherein the energy is reflected in an annular configuration.

9. The method in accordance with claim 7 wherein the package includes an opening wholly within the material at which a dispensing element is affixed to the package, and wherein the infrared energy emitting element is positioned at about the opening to emit energy in the direction of the first surface at the edge-proximate portion of the opening and wherein the energy reflective element is positioned opposite the energy emitting element to reflect infrared energy back to the second surface at the edge-proximate portion.

10. The method in accordance with claim 9 wherein the reflective element is configured to reflect the infrared energy to the edge-proximate area in favor of reflecting the infrared energy back toward the energy emitting element.
